(19) United States
(12) Patent Application Publication
(10) Pub. No.: US 2021/0073005 A1
(43) Pub. Date: Mar. 11, 2021

(54) METHOD, APPARATUS, DEVICE AND STORAGE MEDIUM FOR STARTING PROGRAM

(71) Applicant: BAIDU ONLINE NETWORK TECHNOLOGY (BEIJING) CO., LTD., BEIJING (CN)

(72) Inventors: XIAONING XI, BEIJING (CN); BING HAN, BEIJING (CN); XIAOJING DING, BEIJING (CN); YUE LIU, BEIJING (CN)

(21) Appl. No.: 16/859,847

(22) Filed: Apr. 27, 2020

(30) Foreign Application Priority Data
Sep. 9, 2019 (CN) 201910864903.7

(51) Int. Cl. G06F 9/445; G06F 9/4401; H04M 1/725

(52) U.S. Cl. CPC G06F 9/44505; H04M 1/72577; G06F 9/4418; G06F 9/44584

(57) ABSTRACT

Provided are a method, an apparatus, a device, and a storage medium for starting a program, relating to a program automatic pull-up technology. A specific implementation is: receiving, by an electronic device, a first control instruction sent by a smart device, where the control instruction is sent by the smart device through a Bluetooth connection after the Bluetooth connection is established between the electronic device and the smart device; determining, by the electronic device, a preset program according to the first control instruction, and running the preset program so that a preset page of the preset program is displayed in the electronic device. The method of the present disclosure may reduce the steps for a user to manually search for and open the preset program, making the process of controlling the smart device by the user through the electronic device easier.

### CROSS-REFERENCE TO RELATED APPLICATIONS

This application claims priority to Chinese Patent Application No. 201910864903.7, filed on Sep. 9, 2019, which is incorporated herein by reference in its entirety.

### TECHNICAL FIELD

The present disclosure relates to a program starting technology, and more particularly to a program automatic pull-up technology.

### BACKGROUND

There are currently many smart devices that can be connected to mobile phones, such as in-vehicle mobile phone holders, Bluetooth speakers, sports bracelets, and so on. These smart devices can be connected to the mobile phones in the manner of Bluetooth connection.

In the prior art, an APP matched with a smart device can be installed in a mobile phone, and a user can operate in the APP so as to use functions of the smart device. For example, a music could be selected in the APP to make a smart speaker connected to the mobile phone play the music.

However, in the existing technical solutions, after the mobile phone is connected to the smart device, the user is required to manually operate the mobile phone to find an APP that is matched with the smart device, open the APP and then operate in the APP. Therefore, the way of controlling a smart device by mobile phone in the prior art is too complicated.

### SUMMARY

The present disclosure provides a method, an apparatus, a device, and a storage medium for starting a program, so as to solve the problem that the process of a program starting is complicated in the prior art.

A first aspect of the present disclosure provides a method for starting a program, including:

receiving, by an electronic device, a first control instruction sent by a smart device, where the first control instruction is sent by the smart device through a Bluetooth connection after the Bluetooth connection is established between the electronic device and the smart device; and

determining, by the electronic device, a preset program according to the first control instruction, and running the preset program so that a preset page of the preset program is displayed in the electronic device.

In the method provided by the present disclosure, after establishing the Bluetooth connection between the electronic device and the smart device, the preset program can be automatically pulled up by receiving the first control instruction sent by the smart device, and the preset page of the preset program also can be displayed on an interface, thereby reducing the steps of manually searching for and opening the preset program, making the process of controlling the smart device by the user through the electronic device easier.

In an optional embodiment, before the receiving, by an electronic device, a first control instruction sent by a smart device, the method further includes:

receiving, by the electronic device, a second control instruction sent by the smart device, where the second control instruction is sent by the smart device through a Bluetooth connection after the Bluetooth connection is established between the electronic device and the smart device;

displaying, by the electronic device, at least one selectable program according to the second control instruction; and

determining, by the electronic device, a selected first program as the preset program in response to an operation instruction for selecting a first program,

where the selectable program includes the first program.

According to the solution provided in this embodiment, the program selected can be used as the preset program, and thereby a specified program could be pulled up through the Bluetooth connection.

In an optional embodiment, the method further includes:

determining, by the electronic device, the number of the selectable program according to the second control instruction, and if the number is 1, determining the selectable program as the preset program.

If the number of the selectable program is 1, the selectable program can be directly determined as the preset program without user's selection, thereby the operation steps that need to be executed by the user are further simplified.

In an optional embodiment, if the number is greater than 1, then the electronic device executes the step of displaying at least one selectable program according to the second control instruction.

When the number of the selectable program is greater than 1, these selectable programs are displayed, and thereby the preset program to be automatically pulled up could be specified by the user.

In an optional embodiment, after the displaying, by the electronic device, at least one selectable program according to the second control instruction, the method further includes:

closing, by the electronic device, a display control for displaying at least one of the selectable program in response to a rejection instruction for refusing to select the selectable program.

If the user does not want any program to be automatically pulled up, based on this embodiment, the display control for displaying the at least one selectable program may be directly closed in response to the rejection instruction, which does not affect a normal use of the user.

In an optional embodiment, after the determining a selected first program as the preset program, the method further includes:

obtaining and displaying, by the electronic device, modification guide information in response to an opening instruction for opening a second program,

where the selectable program includes the second program.

Displaying the modification guide information in a selectable program not designated to be a preset program facilitates the user to modify the preset program.

In an optional embodiment, the method further includes:

displaying, by the electronic device, a system setting page corresponding to the first program, in response to a modification instruction generated by operating on a page displaying the modification guide information; and

clearing, by the electronic device, information of using the first program as the preset program, in response to a clear instruction for clearing default open information of the first program.

Jumping directly a corresponding setting page in response to a user's operation on the modification guide information can further reduce the number of the user's operation steps.

In an optional embodiment, after clearing information of using the first program as the preset program, the method further includes:

obtaining and displaying, by the electronic device, at least one of the selectable program, in response to a wake-up instruction for waking up the second program.

After clearing the information of a current preset program, the selectable program can be displayed again, thereby the user can use other program as the preset program, and the user can set these selectable programs without the user's operation to find these selectable programs.

In an optional embodiment, before the displaying, by the electronic device, at least one selectable program according to the second control instruction, the method further includes:

displaying, by the electronic device, a setting page corresponding to the first program, in response to an instruction for opening the setting page of the first program; and

determining, by the electronic device, the first program as the selectable program, in response to an instruction for setting an automatic pull-up function of the first program.

An automatic pull-up function of a program can be opened in response to a user's operation, thereby meeting a user's requirement.

In an optional embodiment, before the displaying, by the electronic device, at least one selectable program according to the second control instruction, the method further includes:

displaying, by the electronic device, a setting page corresponding to a third program, in response to an instruction for opening the setting page of the third program; and

clearing, by the electronic device, information of determining the third program as the selectable program, in response to an instruction for canceling an automatic pull-up function of the third program.

An automatic pull-up function of a program is closed in response to a user's operation, thereby meeting a user's requirement.

In an optional embodiment, the method further includes:

obtaining and displaying, by the electronic device, the preset page of the preset program, in response to a screen lock instruction.

The preset page of the preset program can still be displayed when the device is locked, which facilitates the user to operate the preset program.

A second aspect of the present disclosure provides an apparatus for starting a program, including:

a receiving module, configured to receive a first control instruction sent by a smart device, where the first control instruction is sent by the smart device through a Bluetooth connection after the Bluetooth connection is established between an electronic device and the smart device; and

a determining module, configured to determine a preset program according to the first control instruction, and run the preset program so that a preset page of the preset program is displayed in the electronic device.

A third aspect of the present disclosure provides an electronic device, including:

at least one processor; and

a memory in communication with the at least one processor; where

the memory stores instructions that is executable by the at least one processor, and the instructions are executed by the at least one processor to enable the at least one processor to execute the method for starting a program as described in any option of the first aspect.

A fourth aspect of the present disclosure provides a non-transitory computer-readable storage medium, storing computer instructions that cause a computer to execute the method for starting a program as described in any option of the first aspect.

An embodiment of the above application has the following advantages or beneficial effects:

According to the starting method, apparatus, device and storage medium provided by the present disclosure, after an electronic device established a Bluetooth connection with a smart device, it is possible to automatically pull-up a preset program by receiving a first control instruction sent by the smart device, and it is also possible to display a preset page of the preset program on the interface, thereby reducing the steps of user manually searching for the preset program and opening the preset program, which makes the process of controlling the smart device by the electronic device easier for the user.

### BRIEF DESCRIPTION OF DRAWINGS

The drawings are used to better understand the technical solution, and do not constitute a limitation on the disclosure, in which:

FIG. 1 is a structural diagram of a system according to an embodiment;

FIG. 2 is a schematic diagram of an interface of an electronic device according to an embodiment;

FIG. 3 is a flowchart of a method for starting a program according to an embodiment of the present disclosure;

FIG. 3A is a schematic diagram of a first interface according to an embodiment of the present disclosure;

FIG. 4 is a flowchart of a method for starting a program according to another embodiment of the present disclosure;

FIG. 4A is a schematic diagram of a second interface according to an embodiment of the present disclosure;

FIG. 4B is a schematic diagram of a third interface according to an embodiment of the present disclosure;

FIG. 4C is a schematic diagram of a fourth interface according to an embodiment of the present disclosure;

FIG. 4D is a schematic diagram of a fifth interface according to an embodiment of the present disclosure;

FIG. 4E is a schematic diagram of a sixth interface according to an embodiment of the present disclosure;

FIG. 5 is a flowchart of a method for determining a selectable program according to an embodiment of the present disclosure;

FIG. 5A is a schematic diagram of a seventh interface according to an embodiment of the present disclosure;

FIG. 5B is a schematic diagram of an eighth interface according to an embodiment of the present disclosure;

FIG. 6 is a flowchart of a method for clearing a selectable program according to an embodiment of the present disclosure;

FIG. 6A is a schematic diagram of a ninth interface according to an embodiment of the present disclosure;

FIG. 7 is a structural diagram of an apparatus for starting a program according to an embodiment of the present disclosure;

FIG. 8 is a structural diagram of an apparatus for starting a program according to another embodiment of the present disclosure; and

FIG. 9 is a block diagram of an electronic device according to another embodiment of the present disclosure.

### DESCRIPTION OF EMBODIMENTS

Exemplary embodiments of the present disclosure are described in the following with reference to the drawings, including various details of the embodiments of the present disclosure to facilitate understanding, and they should be considered as merely exemplary. Therefore, those of skilled in the art should recognize that various changes and modifications can be made to the embodiments described herein without departing from the scope and spirit of the present disclosure. Also, for clarity and conciseness, descriptions of well-known functions and structures are omitted in the following description.

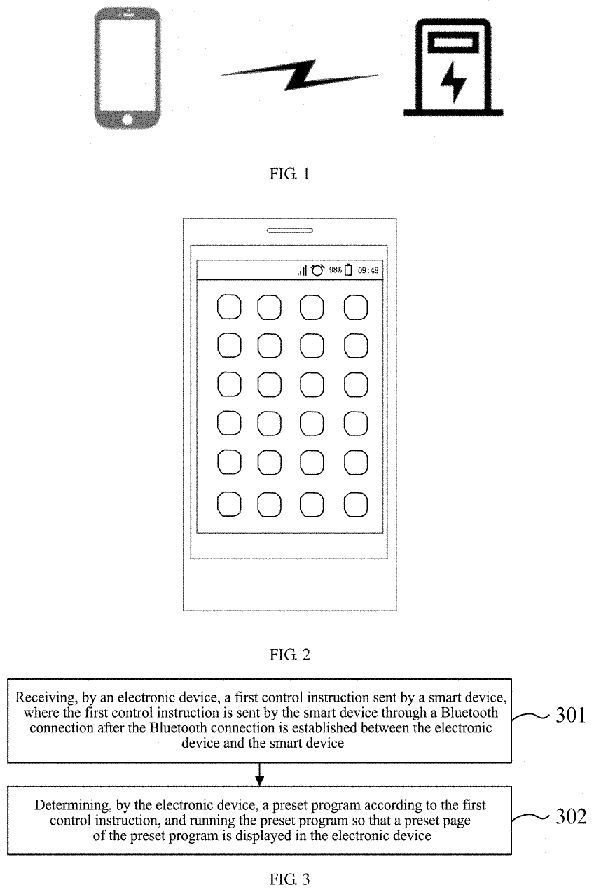

FIG. 1 is a structural diagram of a system according to an embodiment.

As shown in FIG. 1, at present, some smart devices 11 can be connected to an electronic device 12, for example, a mobile phone, a tablet computer with Bluetooth function, and the like, through Bluetooth.

After the smart device 11 and the electronic device 12 are connected, a user can operate the electronic device 12 to search a program matching the smart device 11 and open the program for operation. If there are many applications installed in the electronic device 12, it will take a longer time for the user to find the program. As shown in FIG. 2, there are twenty-four programs icons displayed on one page of the electronic device 12. If the electronic device 12 includes three similar pages, the user needs to search the program to be opened among the three pages. This process is complicated, and wastes the user a longer period of time.

In a solution of starting a program provided by the present disclosure, a preset program can be automatically pulled up through a control instruction sent by a smart device through a Bluetooth connection, thereby eliminating the need for a user to search and open the program.

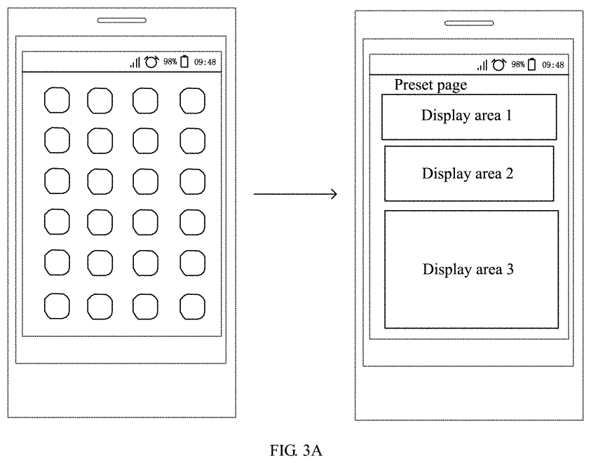

FIG. 3 is a flowchart of a method for starting a program according to an embodiment of the present disclosure.

As shown in FIG. 3, the method for starting a program provided in this embodiment includes:

Step 301, receiving, by an electronic device, a first control instruction sent by a smart device, where the control instruction is sent by the smart device through a Bluetooth connection after the Bluetooth connection is established between the electronic device and the smart device.

Where the method provided in this embodiment is executed by an electronic device. Specifically, the method provided in this embodiment may be encapsulated in an application program, and the application program may be installed in the electronic device to execute the method provided in this embodiment. The electronic device may be, for example, the electronic device 12 shown in FIG. 1.

Specifically, the electronic device has a function of Bluetooth communication.

Further, the smart device may be a device having a Bluetooth communication function and capable of interacting with an electronic device through a Bluetooth connection. For example, it may be a Bluetooth speaker or a Bluetooth headset, etc. It can also be a vehicle-mounted device with a Bluetooth function, such as a vehicle-mounted Bluetooth speaker, a vehicle-mounted Bluetooth mobile phone holder, etc.

In practical applications, the electronic device and the smart device can be connected by pairing. The user can turn on the Bluetooth function of the electronic device, and when the electronic device and the smart device are connected for the first time, the user can enter a pairing code in the electronic device to pair them, and after successful pairing, a Bluetooth connection can be established between the electronic device and the smart device. Thereafter, if the Bluetooth function of the electronic device is turned on and the electronic device enters the Bluetooth scanning range of the smart device, a connection can be automatically established between them.

Where the first control instruction may be sent to the electronic device through the Bluetooth connection after the smart device establishes a connection with the electronic device, and the control instruction may be, for example, a voice-command, thereby the smart device can receive the first control instruction.

Step 302, determining, by the electronic device, a preset program according to the first control instruction, and running the preset program so that a preset page of the preset program is displayed in the electronic device.

Specifically, a program may be preset in the electronic device, and the electronic device runs the preset program after receiving the first control instruction.

Further, the preset program may be preset by a user. For example, a program has a function of being pulled up automatically, and the user can start the function of being pulled up automatically of the program so that the program is determined by the electronic device as a preset program.

In an actual application, a program matched with a smart device may have an automatic pull-up function, and a user may launch the automatic pull-up function of the program.

Where, after receiving the first control instruction, the electronic device may determine the preset program according to the setting information.

In another embodiment, a program identifier may be set in the first control instruction. For example, after the smart device establishes a connection with the electronic device, the smart device may obtain an identifier of a matching program, and the identifier may be stored, for example, in the smart device. The smart device may generate the first control instruction including this identifier and send it to the electronic device via a Bluetooth connection. After receiving the first control instruction, the electronic device can identify the program identifier included therein and run a preset program corresponding to the program identifier.

Where the electronic device may determine the preset program by analyzing the first control instruction.

Specifically, after starting the preset program, the electronic device also displays a preset interface of the preset program in an interface. The interface may be, for example, a homepage of the preset program, or a sub-page of the preset program.

Further, the user may add a device in the preset program in advance, such as adding a Bluetooth speaker, then when the preset program is running, a subpage corresponding to the Bluetooth speaker may be automatically displayed.

In an actual application, the electronic device may determine the type of the smart device through the first control instruction or the device identifier that establishes a Bluetooth connection with the electronic device, so that the sub-page of the preset program may be displayed according to the type of the smart device. For example, at least one type of smart device is matched with one program, that is, the program can interact with multiple smart devices. At this time, a preset page of the preset program may be displayed according to the type of the smart device. For example, if the smart device is a Bluetooth speaker, the electronic device may open a subpage corresponding to the Bluetooth speaker in the preset program, thereby further reducing the operation steps of the user.

FIG. 3A is a schematic diagram of a first interface according to an embodiment of the present disclosure.

As shown in FIG. 3A, before the smart device establishes a Bluetooth connection with the electronic device, an interface of the electronic device, as shown in the interface diagram on the left of FIG. 3A, can be kept on a menu page or display an interface of an application. This embodiment does not limit this here.

After the smart device establishes a Bluetooth connection with the electronic device, the electronic device receives the first control instruction sent by the smart device and processes it. A display result of the interface of the electronic device is shown in the interface diagram on the right of FIG. 3A, and the interface can display the preset page of preset program.

This process does not need to operate the electronic device by the user, thereby reducing complexity for the user to operate the electronic device.

The method provided in this embodiment is used to automatically pull up a program. The method is executed by a device set with the method provided in this embodiment, and the device is usually implemented in hardware and/or software.

The method for starting a program provided in this embodiment includes: receiving, by an electronic device, a first control instruction sent by a smart device, where the control instruction is sent by the smart device through a Bluetooth connection after the Bluetooth connection is established between the electronic device and the smart device; and determining, by the electronic device, a preset program according to the first control instruction, and running the preset program so that a preset page of the preset program is displayed in the electronic device. According to the method provided by the present embodiment, after establishing the Bluetooth connection between the electronic device and the smart device, the electronic device can automatically pulling up the preset program by receiving the first control instruction sent by the smart device, and can also display the preset page of the preset program in an interface, thereby reducing the steps of manually searching for the preset program and opening the preset program, which makes the process of controlling the smart device by the electronic device easier for the user.

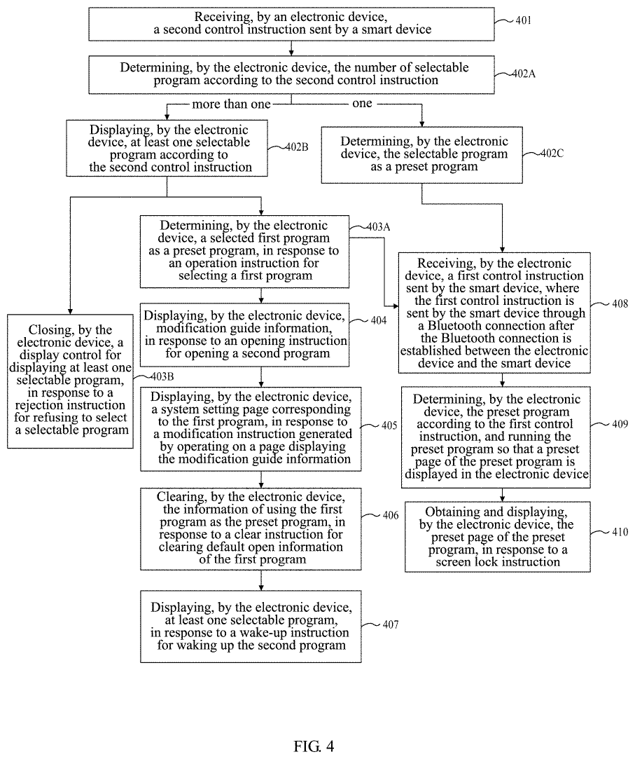

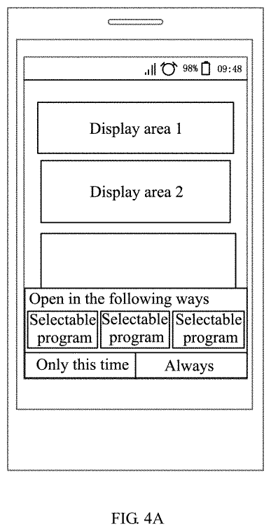

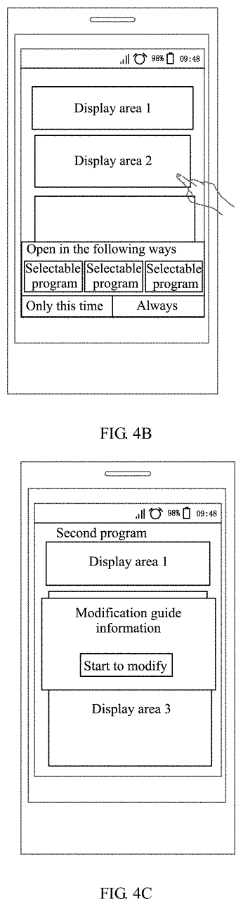

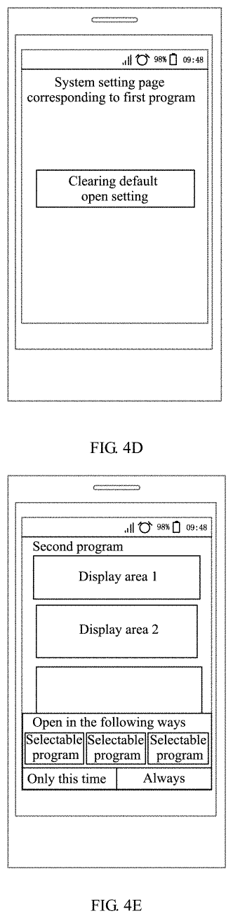

FIG. 4 is a flowchart of a method for starting a program according to another embodiment of the present disclosure.

As shown in FIG. 4, the method for starting a program provided in this embodiment includes:

Step 401, receiving, by an electronic device, a second control instruction sent by a smart device.

Where the second control instruction is sent by the smart device through a Bluetooth connection after the electronic device establishes the Bluetooth connection with the smart device.

Specifically, in the method provided by this embodiment, if a preset program is not set in the electronic device, then after the smart device establishes the Bluetooth connection with the electronic device, the electronic device may receive the second control instruction sent by the smart device.

Further, the second control instruction and the first control instruction may be the same instruction. The first and second here are used to distinguish control instructions received by the electronic device at different stages. When the preset program is not set in the electronic device, the electronic device receives the second control instruction, and when the preset program is set in the electronic device, the electronic device receives the first control instruction.

In practical applications, the first control instruction and the second control instruction may both be voice-command instructions.

The manner in which the electronic device receives the second control instruction is similar to the manner in which it receives the first control instruction.

Step 402B: displaying, by the electronic device, at least one selectable program according to the second control instruction.

Where since the electronic device does not have the preset program when the electronic device receives the control instruction, at this time, the electronic device may take the control instruction as the second control instruction for processing. For displaying at least one selectable program in an interface, the user can operate the electronic device to determine a preset program among the selectable program.

Specifically, the selectable program refers to a program that can be automatically pulled up. For example, if a program A is set to be automatically pulled up, the electronic device may use it as a selectable program.

Further, the electronic device may include at least two selectable programs, and may also include one or no selectable program.

FIG. 4A is a schematic diagram of a second interface according to an embodiment of the present disclosure.

As shown in FIG. 4A, three selectable programs can be displayed in an interface of the electronic device. In addition, the options “only this time” and “always” can be displayed.

The user can select any one of the selectable programs and select “Only this time” or “Always” to determine a preset program.

If the user selects “Only this time”, then the selected program is used as the preset program only during the current communication process by Bluetooth connection, that is, the program can be pulled up by the smart device this time. After the Bluetooth connection is disconnected, when the electronic device is successfully connected with the smart device next time, the electronic device will take a received control instruction as the second control instruction for processing.

If the user selects “Always”, then the electronic device always uses the selected program as a preset program.

In an actual application, the method provided in this embodiment may include step 402A before step 402B. That is, step 402B may be executed directly after step 401, or step 402A may be executed after step 401.

Step 402A, determining, by the electronic device, the number of the selectable program according to the second control instruction.

Where the electronic device can detect the number of internal selectable program(s). The following are descriptions for different numbers.

When the number of the selectable program is two or more, step 402B is executed to display these selectable programs. If step 402A is set, at least two selectable programs are displayed.

When the number of the selectable program is 1, step 402C is executed.

Step 402C, determining, by the electronic device, the selectable program as a preset program.

Specifically, if the number of the selectable program is 1, the selectable program can be set as a preset program by the electronic device by default without need for the user to operate.

Further, if the number of the selectable program is 0, it means that there is no program that can be automatically pulled up, and thereafter the process can be ended.

After step 402B, step 403A may be further included.

In step 403A, the electronic device determines the selected first program as a preset program in response to an operation instruction for selecting the first program.

In the actual application, when selectable programs are displayed in the interface of a user terminal the user can operate the electronic device and select a program from the selectable programs as the preset program. For example, the user can click one of the selectable programs, and also click the buttons of “Always” and “Only this time”, thereby the electronic device could receive the operation instruction.

Where the electronic device determines the selected first program as the preset program in response to an operation instruction for selecting the first program. The first program is a selectable program selected by the user.

Specifically, the electronic device may use the first program as a current preset program or always use a preset program according to the “Always” or “Only this time” selected by the user.

Optionally, the method provided in this embodiment may also include step 403B.

Step 403B, closing, by the electronic device, a display control for displaying at least one selectable program, in response to a rejection instruction for refusing to select a selectable program.

In one case, the user may not want to use any one of the displayed selectable programs as a preset program, and at this time the user may operate the electronic device to send to the electronic device a rejection instruction for rejecting the selection from the selectable programs. For example, the user may click an area outside the display control for displaying at least one selectable program, in the interface, thereby triggering the electronic device to close the display control.

FIG. 4B is a schematic diagram of an third interface according to an embodiment of the present disclosure.

As shown in FIG. 4B, the user can put his finger on a position as shown in this Figure. After the electronic device detects this operation of the user, the electronic device may close the display control for displaying at least one selectable program in response to the rejection instruction.

Optionally, the method provided in this embodiment may further include step 404.

Step 404, displaying, by the electronic device, modification guide information, in response to an opening instruction for opening a second program.

Where the selectable programs include the second program.

In one case, the user may select a wrong program, causing the first program to be used as a preset program. For example, the selectable programs include the first program, the second program, and a third program. The user wants to select the second program as the preset program, but wrongly select the first program as the preset program.

At this time, the user can operate the electronic device to open the second program.

The electronic device can identify that the second program is a selectable program, and can also identify that an optional program is set as the preset program. Then when the electronic device opens the second program, the electronic device may further display the modification guide information corresponding to the second program.

FIG. 4C is a schematic diagram of a fourth interface according to an embodiment of the present disclosure.

As shown in FIG. 4C, after the user operates the electronic device to open the second program, the guidance modification information may be displayed on the interface of the second program.

Where the mode for displaying the guidance modification information can be also encapsulated in the program. For example, after setting the first program as the preset program, when the electronic device opens the second program, the modification guide information can be displayed. However, if the second program is set as a preset program, when the electronic device opens the first program, the modification guidance information corresponding to the first program is not displayed.

As shown in FIG. 4C, the control for displaying the guide modification information may further include an operable control, such as a button for starting modification.

Step 405, displaying, by the electronic device, a system setting page corresponding to the first program, in response to a modification instruction generated by operating on a page displaying the modification guide information.

Specifically, the user can operate a button for starting the modification, for example, clicking the button to send a modification instruction to the electronic device.

Further, the electronic device may respond to the modification instruction and display a system setting page corresponding to the first program. After receiving the modification instruction, the electronic device may determine that the first program is currently set as the preset program, and the electronic device displays the system setting page corresponding to the first program, thereby the user can operate it and clear the information of the first program being the preset programs.

FIG. 4D is a schematic diagram of a fifth interface according to an embodiment of the present disclosure.

As shown in FIG. 4D, the electronic device displays a system setting page corresponding to the first program, as shown in this figure, in response to the modification instruction. And this page can also include a button for clearing the default open setting. The use may operate the button to clear the information of the first program being the preset program.

Step 406, clearing, by the electronic device, the information of using the first program as the preset program, in response to a clear instruction for clearing the default open information of the first program.

Where if the user clicks the button for clearing the information of the first program being the preset program, the electronic device can respond to the clear instruction and clear the information that the first program is the preset program.

Specifically, the user may continue to operate the electronic device to open the second program again.

Step 407, displaying, by the electronic device, at least one selectable program, in response to a wake-up instruction for waking up the second program.

Further, if the user operates the electronic device for returning to the second program, the electronic device may display at least one optional program based on the interface of the second program.

For example, if the user does not close the second program opened previously, the program can be awakened directly in an application manager of the electronic device, and thereby the second program is displayed on the first layer of the interface.

In an actual application, at least one selectable program may be displayed on the upper layer of the interface of the second program.

FIG. 4E is a schematic diagram of a sixth interface according to an embodiment of the present disclosure.

As shown in FIG. 4E, the user can re-select a preset program by operating on this interface. For example, the second program may be used as the preset program, thereby entering to step 403A.

After steps 403A and 402C, the method may further include:

Step 408, receiving, by the electronic device, a first control instruction sent by the smart device, where the first control instruction is sent by the smart device through a Bluetooth connection after the Bluetooth connection is established between the electronic device and the smart device.

Step 409, determining, by the electronic device, the preset program according to the first control instruction, and running the preset program so that a preset page of the preset program is displayed in the electronic device.

Steps 408-409 have similar implementation principles and effects to steps 301-302 and will not be described again.

Step 410, obtaining and displaying, by the electronic device, the preset page of the preset program, in response to a screen lock instruction.

In one embodiment, if the preset program is pulled up by the smart device and the preset page of the preset program is displayed on the electronic device, then when the electronic device receives the screen lock instruction, the preset page of the preset program can be obtained and displayed, that is, the electronic device does not enter the screen saver after receiving the screen lock instruction, and still displays the preset page.

For example, when it is inconvenient for the user to operate the electronic device, this manner is convenient for the user to control the electronic device through other methods, such as by voice. For example, when the user is driving, the solution provided in this embodiment can prevent screen of the electronic device from being locked, and thus does not require to manually unlock the screen by the user.

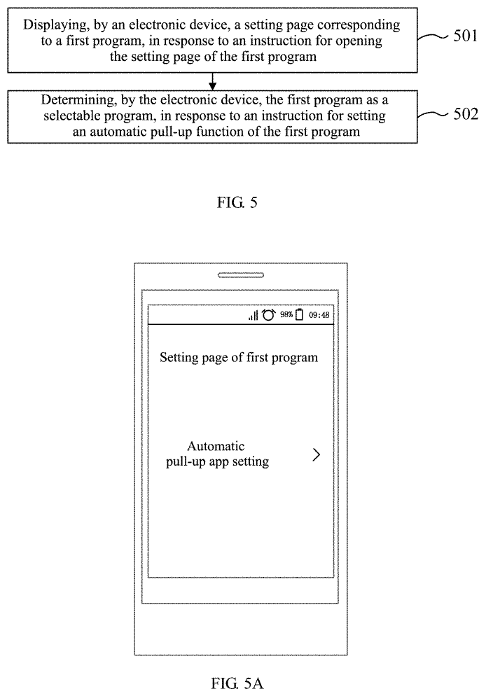

FIG. 5 is a flowchart of a method for determining a selectable program according to an embodiment of the present disclosure.

As shown in FIG. 5, the method for determining a selectable program provided in this embodiment includes:

Step 501, displaying, by an electronic device, a setting page corresponding to a first program, in response to an instruction for opening the setting page of the first program.

The method provided in this embodiment may set the first program as a selectable program, thereby when the electronic device displays the selectable program, the first program can be displayed.

Specifically, the user may operate the electronic device so that the electronic device receives the instruction for opening the setting page of the first program, and display the setting page corresponding to the first program in response to the instruction.

FIG. 5A is a schematic diagram of a seventh interface according to an embodiment of the present disclosure.

As shown in FIG. 5A, the setting page corresponding to the first program can be obtained and displayed by the electronic device.

For example, the user may click the “Setting” button of the first program, and then trigger the electronic device to display the setting page of the program.

Step 502, determining, by the electronic device, the first program as a selectable program, in response to an instruction for setting an automatic pull-up function of the first program.

FIG. 5B is a schematic diagram of an eighth interface according to an embodiment of the present disclosure.

As shown in FIG. 5B, a switch for automatic pull-up function of the first program can be set in the setting page of the first program, and the user can operate the electronic device to send to the electronic device an instruction for launching the automatic pull-up function of the first program. The setting page of the first program can be changed from 5A to 5B.

The electronic device could determine the first program as the selectable program in response to an instruction for setting the automatic pull-up function of the first program. For example, a variable list may be maintained, the variable list includes a variable A corresponding to the first program, and the electronic device may change the variable A to 1 in response to the instruction for setting the automatic pull-up function of the first program.

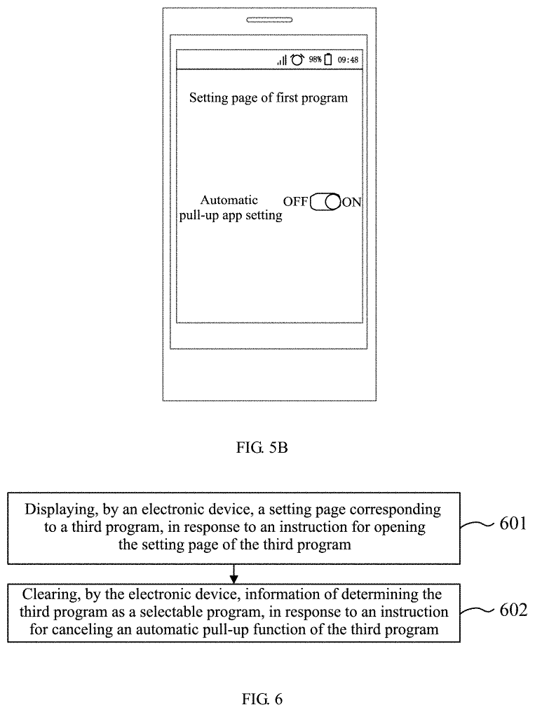

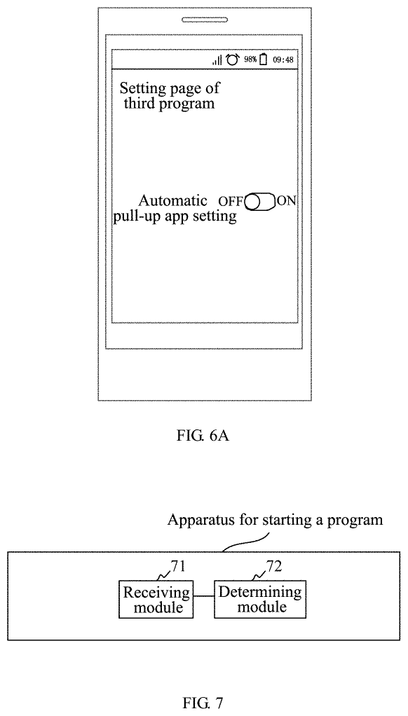

FIG. 6 is a flowchart of a method for clearing a selectable program according to an embodiment of the present disclosure.

As shown in FIG. 6, the method for clearing a selectable program provided in this embodiment includes:

Step 601, displaying, by an electronic device, a setting page corresponding to a third program, in response to an instruction for opening the setting page of the third program.

Where, the method provided in this embodiment may cancel setting the third program as a selectable program, thereby when the electronic device displays selectable programs, the third program is not be displayed. Specifically, the user may operate the electronic device so that the electronic device receives the instruction for opening the setting page of the third program, and displays the setting page corresponding to the third program in response to the instruction.

For example, the user may click the “Setting” button of the third program, and then trigger the electronic device to display the setting page of the program. The setting page of the third program is similar to that shown in FIG. 5A and will not be described again.

Step 602, clearing, by the electronic device, information of determining the third program as a selectable program, in response to an instruction for canceling an automatic pull-up function of the third program.

FIG. 6A is a schematic diagram of a ninth interface according to an embodiment of the present disclosure.

As shown in FIG. 6A, a switch for the automatic pull-up function of the third program can be set on the setting page of the third program, and the user can operate the electronic device to send to the electronic device an instruction for closing the automatic pull-up function of the third program.

The electronic device may cancel the information of determining the third program as the preset program, in response to a clear instruction for setting to clear the default open information of the third program. For example, a variable list may be maintained, the variable list includes a variable C corresponding to the third program, and the electronic device may change the variable C to 0 in response to the clear instruction.

Correspondingly, if the automatic pull-up function of the third program is closed, the electronic device can also clear the information that the third program is used as the preset program.

The first program and the third program may be the same program or different programs, and this embodiment does not limit this.

Optionally, in another embodiment, the information that a program is used as a preset program may be cleared through a system setting page.

The electronic device displays a setting page corresponding to the first program in response to a setting instruction for opening the system setting page; the electronic device clears information of using the first program as the preset program in response to a clear instruction for clearing the default open information of the first program.

The user can operate the electronic device so that the electronic device opens the system setting page; and operate on this system setting page so that the electronic device opens the setting page of the first program, as shown in FIG. 4D.

The user can operate a button for clearing the default open information of the first program, so that the electronic device receives a clear instruction for clearing the default open information of the first program, and clears the information that the first program is the preset program.

FIG. 7 is a structural diagram of an apparatus for starting a program according to an embodiment of the present disclosure.

As shown in FIG. 7, the apparatus for starting a program provided in this embodiment includes:

a receiving module 71, configured to receive a first control instruction sent by a smart device, where the first control instruction is sent by the smart device through a Bluetooth connection after the Bluetooth connection is established between an electronic device and the smart device; and

a determining module 72, configured to determine a preset program according to the first control instruction, and run the preset program so that a preset page of the preset program is displayed in the electronic device.

The principle, realization mode, and effect of the apparatus for starting a program provided in this embodiment are similar to the embodiment shown in FIG. 3, and the details are not described here again.

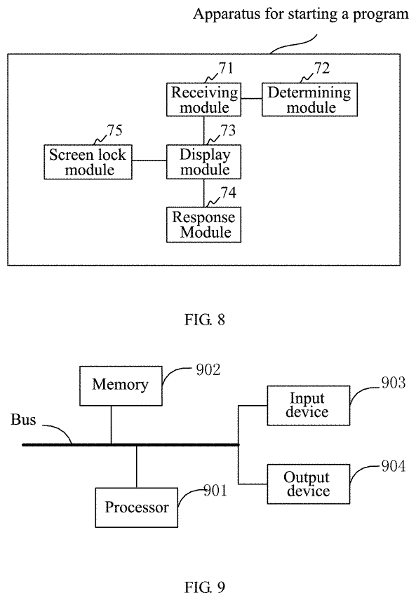

FIG. 8 is a structural diagram of an apparatus for starting a program according to another embodiment of the present disclosure.

As shown in FIG. 8, based on the above embodiment, in the apparatus for starting a program provided in this embodiment, optionally, the receiving module 71 is further configured to:

receive a second control instruction sent by the smart device, where the second control instruction is sent by the smart device through a Bluetooth connection after the electronic device establishes the Bluetooth connection with the smart device.

The apparatus further includes:

a display module 73, configured to display at least one selectable program according to the second control instruction;

a response module 74, configured to determine the selected first program as the preset program in response to an operation instruction for selecting the first program;

Optionally, the determining module 72 is further configured to:

determine the number of the selectable program according to the second control instruction, and if the number is 1, determine the selectable program as the preset program.

Optionally, if the number is greater than 1, the display module 73 executes the step of displaying at least one selectable program according to the second control instruction.

Optionally, the response module 74 is further configured to:

close a display control for displaying at least one selectable program, in response to a rejection instruction for refusing to select the selectable program.

Optionally, the response module 74 is further configured to:

obtain and display the modification guide information, in response to an opening instruction for opening the second program;

where the selectable program includes the second program.

Optionally, the response module 74 is further configured to:

display a system setting page corresponding to the first program, in response to a modification instruction generated by operating on a page displaying the modification guide information; and

clear the information of using the first program as the preset program, in response to a clear instruction for clearing the default open information of the first program.

Optionally, the response module 74 is further configured to:

obtain and display at least one of the selectable program in response to a wake-up instruction for waking up the second program.

Optionally, the response module 74 is further configured to:

display a setting page corresponding to the first program in response to an instruction for opening the setting page of the first program;

determine the first program as the selectable program in response to an instruction for setting an automatic pull-up function of the first program.

Optionally, the response module 74 is further configured to:

display a setting page corresponding to a third program in response to an instruction for opening a setting page of the third program;

clear the information that determines the third program as the selectable program in response to an instruction for canceling the automatic pull-up function of the third program.

Optionally, the apparatus further includes:

a screen lock module 75, configured to:

obtain and display the preset page of the preset program in response to a screen lock instruction.

According to an embodiment of the present disclosure, the present disclosure further provides an electronic device and a readable storage medium.

FIG. 9 is a block diagram of an electronic device for starting a program according to an embodiment of the present disclosure. The electronic devices are intended to represent various forms of digital computers, such as laptop computers, desktop computers, workbenches, personal digital assistants, servers, blade servers, mainframe computers, and other suitable computers. The electronic devices may also represent various forms of mobile devices, such as personal digital processing, cellular phones, smart phones, wearable devices, and other similar computing devices. The components shown herein, their connections and relationships, and their functions are merely exemplary and are not intended to limit the implementation of the present disclosure described and/or claimed herein.

As shown in FIG. 9, the electronic device includes: one or more processors 901, a memory 902, and interfaces for connecting various components, including high-speed interfaces and low-speed interfaces. The various components are interconnected using different buses and can be mounted on a common motherboard or otherwise installed as required. The processor may process instructions executable within the electronic device, including instructions stored in or on the memory to display graphical information of the GUI on an external input/output device (such as a display device coupled to an interface). In other embodiments, multiple processors and/or multiple buses can be used together with multiple memories if desired. Similarly, multiple electronic devices can be connected, each providing some of necessary operations (for example, as a server array, a group of blade servers, or a multiprocessor system). A processor 901 is taken as an example in FIG. 9.

The memory 902 is a non-transitory computer-readable storage medium provided by the present disclosure. Where the memory stores instructions executable by at least one processor, so that the at least one processor executes the method for starting a program provided by the present disclosure. The non-transitory computer-readable storage medium of the present disclosure stores computer instructions for causing a computer to execute the method of starting a program provided by the present disclosure.

The memory 902, as a non-transitory computer-readable storage medium, may be used to store non-transitory software programs, non-transitory computer-executable programs, and modules, such as program instructions/modules (for example, the receiving module 71 and the determining module 72 shown in FIG. 7) corresponding to the method for starting a program in the embodiments of the present disclosure. The processor 901 executes various functional applications and data processing of the server by running the non-transitory software programs, instructions, and modules stored in the memory 902, thereby achieving the methods for starting a program in the above method embodiments.

The memory 902 may include a storage program area and a storage data area, where the storage program area may store an operating system and an application program required for at least one function; the storage data area may store data created according to the use of the electronic device for starting a the program, etc. In addition, the memory 902 may include a high-speed random access memory, and may also include a non-transitory memory, such as at least one magnetic disk storage device, a flash memory device, or other non-transitory solid-state storage device. In some embodiments, the memory 902 may optionally include memories remotely disposed with respect to the processor 901, and these remote memories may be connected to the electronic device for starting a program through a network. Examples of the above network include, but are not limited to, an internet, an enterprise intranet, a local area network, a mobile communication network, and combinations thereof.

The electronic device of the method for starting a program may further include: an input device 903 and an output device 904. The processor 901, the memory 902, the input device 903, and the output device 904 may be connected through a bus or in other manner. In FIG. 9, the bus connection is taken as an example.

The input device 903 may receive inputted numeric or character information, and generate key signal inputs related to user settings and function control of the electronic device for starting a program, such as a touch screen, a keypad, a mouse, a trackpad, a touchpad, a pointing stick, one or more input devices such as mouse buttons, trackballs, and joysticks. The output device 904 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in a digital electronic circuitry system, an integrated circuit system, an ASIC (application specific integrated circuits), computer hardware, firmware, software, and/or combinations thereof. These various embodiments may include: implemented in one or more computer programs, the one or more computer programs is executable and/or interpretable on a programmable system including at least one programmable processor, the programmable processor may be a dedicated or general-purpose programmable processor that can receive data and instructions from a storage system, at least one input device, and at least one output device, and transmit the data and the instructions to the storage system, the at least one input device, and the at least one output device.

These computing programs (also known as programs, software, software applications, or codes) include machine instructions of a programmable processor, and can be implemented using high-level processes and or object-oriented programming languages, and/or assembly/machine languages. As used herein, the terms “machine-readable medium” and “computer-readable medium” refer to any computer program product, device, and or apparatus for providing machine instructions and/or data to a programmable processor (e.g., magnetic disks, optical disks, memories, programmable logic devices (PLDs)), including machine-readable media that receive machine instructions as machine-readable signals. The term “machine-readable signal” refers to any signal for providing the machine instructions and/or the data to the programmable processor.

To provide an interaction with the user, the systems and techniques described herein can be implemented on a computer that has: a display device (for example, a CRT (cathode ray tube) or LCD (liquid crystal display) monitor) for displaying information to the user; and a keyboard and pointing device (such as a mouse or trackball), through which the user can provide an input to the computer. Other kinds of devices may also be used to provide the interaction with the user; for example, the feedback provided to the user may be any form of sensory feedback (e.g. visual feedback, auditory feedback, or haptic feedback); and an input from the user may be received in any form (including acoustic input, voice input, or tactile input).

The systems and technologies described herein can be implemented in a computing system that includes back-end components (for example, as a data server), or a computing system that includes middleware components (for example, an application server), or a computing system that includes front-end components (for example, a user computer with a graphical user interface or web browser, through which the user can interact with the implementation of the systems and technologies described herein), or a computing system that includes any combination of such back-end components, middleware components, or front-end components. The components of the systems may be interconnected by any form or digital data communication (e.g. a communication network) of medium. Examples of the communication network include: local area network (LAN), wide area network (WAN), and internet.

The computer system may include a client and a server. The client and server are generally remote from each other and typically interact through a communication network. The relationship between client and server is generated by a computer program running on the respective computers and having a client-server relationship with each other.

This embodiment also provides a computer program, including program codes. When the computer runs the computer program, the program codes executes any one of the methods for starting a program as described above.

It should be understood that the various forms of the processes shown above can be used to reorder, add, or delete steps. For example, the steps described in the present disclosure can be executed in parallel, sequentially, or in different orders, as long as the desired results of the technical solutions disclosed in the present disclosure can be achieved, there is no limitation on this herein.

The above specific embodiments do not constitute a limitation on the protection scope of the present disclosure. It should be understood by those skilled in the art that various modifications, combinations, sub-combinations, and substitutions may be made according to design requirements and other factors. Any modification, equivalent replacement and improvement made within the spirit and principle of the present disclosure shall be included in the protection scope of the present disclosure.

What is claimed is:

1. A method for starting a program, comprising:
receiving, by an electronic device, a first control instruction sent by a smart device, wherein the first control instruction is sent by the smart device through a Bluetooth connection after the Bluetooth connection is established between the electronic device and the smart device; and
determining, by the electronic device, a preset program according to the first control instruction, and running the preset program so that a preset page of the preset program is displayed in the electronic device.

2. The method according to claim 1, wherein before the receiving, by an electronic device, a first control instruction sent by a smart device, the method further comprises:
receiving, by the electronic device, a second control instruction sent by the smart device, wherein the second control instruction is sent by the smart device through a Bluetooth connection after the Bluetooth connection is established between the electronic device and the smart device;
displaying, by the electronic device, at least one selectable program according to the second control instruction; and
determining, by the electronic device, a selected first program as the preset program in response to an operation instruction for selecting a first program,
where the selectable program comprises the first program.

3. The method according to claim 2, further comprising:
determining, by the electronic device, the number of the selectable program according to the second control instruction, and if the number is 1, determining the selectable program as the preset program.

4. The method according to claim 3, wherein if the number is greater than 1, executing, by the electronic device, the step of displaying at least one selectable program according to the second control instruction.

5. The method according to claim 2, where after the displaying, by the electronic device, at least one selectable program according to the second control instruction, the method further comprises:
closing, by the electronic device, a display control for displaying at least one of the selectable program, in response to a rejection instruction for refusing to select the selectable program.

6. The method according to claim 2, wherein after the determining a selected first program as the preset program, the method further comprises:
obtaining and displaying, by the electronic device, modification guide information in response to an opening instruction for opening a second program;
wherein the selectable program comprises the second program.

7. The method according to claim 6, further comprising:
displaying, by the electronic device, a system setting page corresponding to the first program, in response to a modification instruction generated by operating on a page displaying the modification guide information; and
clearing, by the electronic device, information of using the first program as the preset program, in response to a clear instruction for clearing default open information of the first program.

8. The method according to claim 7, wherein after the clearing the information of using the first program as the preset program, the method further comprises:
obtaining and displaying, by the electronic device, at least one of the selectable program, in response to a wake-up instruction for waking up the second program.

9. The method according to claim 2, wherein before the displaying, by the electronic device, at least one selectable program according to the second control instruction, the method further comprises:
displaying, by the electronic device, a setting page corresponding to the first program, in response to an instruction for opening the setting page of the first program; and
determining, by the electronic device, the first program as the selectable program, in response to an instruction for setting an automatic pull-up function of the first program.

10. An apparatus for starting a program, comprising:
at least one processor; and
a memory connected in communication with the at least one processor,
wherein the memory stores instructions that are executable by the at least one processor, and
wherein the instructions, when executed by the at least one processor, cause the processor to:
receive a first control instruction sent by a smart device, wherein the first control instruction is sent by the smart device through a Bluetooth connection after the Bluetooth connection is established between an electronic device and the smart device; and
determine a preset program according to the first control instruction, and run the preset program so that a preset page of the preset program is displayed in the electronic device.

11. The apparatus according to claim 10, wherein the instructions further cause the processor to:
receive a second control instruction sent by the smart device, wherein the second control instruction is sent by the smart device through a Bluetooth connection after the Bluetooth connection is established between the electronic device and the smart device;
display at least one selectable program according to the second control instruction; and
determine a selected first program as the preset program, in response to an operation instruction for selecting a first program;
wherein the selectable program comprises the first program.

12. The apparatus according to claim 11, wherein the instructions further cause the processor to:
determine the number of the selectable program according to the second control instruction, and if the number is 1, determine the selectable program as the preset program.

13. The apparatus according to claim 12, wherein if the number is greater than 1, then the instructions cause the processor to execute the step of displaying at least one selectable program according to the second control instruction.

14. The apparatus according to claim 11, wherein the instructions further cause the processor to:
close a display control for displaying at least one of the selectable program in response to an rejection instruction for refusing to select the selectable program.

15. The apparatus according to claim 11, wherein the instructions further cause the processor to:
obtain and display modification guide information in response to an opening instruction for opening a second program,
wherein the selectable program comprises the second program.

16. The apparatus according to claim 15, wherein the instructions further cause the processor to:
display a system setting page corresponding to the first program in response to a modification instruction generated by operating on a page displaying the modification guide information; and
clear the information of using the first program as the preset program in response to a clear instruction for clearing default open information of the first program.

17. The apparatus according to claim 16, wherein the instructions further cause the processor to:
obtain and display at least one of the selectable program in response to a wake-up instruction for waking up the second program.

18. The apparatus according to claim 11, wherein the instructions further cause the processor to:
display a setting page corresponding to the first program in response to an instruction for opening the setting page of the first program; and
determine the first program as the selectable program in response to an instruction for setting an automatic pull-up function of the first program.

19. The apparatus according to claim 11, wherein the instructions further cause the processor to:
display a setting page corresponding to a third program in response to an instruction for opening the setting page of the third program; and
clear the information that determines the third program as the selectable program in response to an instruction for canceling an automatic pull-up function of the third program.

20. The apparatus according to claim 10, wherein the instructions further cause the processor to:
obtain and display the preset page of the control program in response to a screen lock instruction.
